(19) United States
(12) Patent Application Publication
(10) Pub. No.: US 2002/0089137 A1
(43) Pub. Date: Jul. 11, 2002

(54) Folding structure of scooter

(76) Inventors: Yun-Chuan Chang, Chung-Ho City (TW); Chuan-Fu Kao, Panchiao City (TW)

Correspondence Address: Yun-Chuan Cang & Chuan-Fu Kao, P.O. Box No. 6-57, Chung-Ho City, Taipei Hsien, 235, TW

(21) Appl. No.: 09/755,125

(22) Filed: Jan. 8, 2001

(51) Int. Cl. B62M 1/00

(52) U.S. Cl. 280/87.041; 280/87.05; 280/639

(57) ABSTRACT

A folding structure of scooter mainly comprises of a front and a rear footboards and a hollow sleeve panel engaged with the front and the rear footboards, wherein the sliding grooves in the shapes of long holes are situated respectively on the side edges of the front and the rear footboards; the through holes disposed respectively on the four corners of the sleeve panel at responding positions to the sliding grooves of the front and the rear footboards for sleeving the front and the rear footboards into the sleeve panel and then insert the bolts to screw the through holes on the sleeve panel and the sliding grooves on the front and the rear footboards to make the front and the rear footboards expandable to be pulled outwards for the user to step on to slide and contractable inside the sleeve panel to reduce the volume for facilitating carriage, shipping and storage.

### BACKGROUND OF THE INVENTION

1) Field of the Invention

The invention herein relates to a folding structure of scooter, particularly a kind of structure capable of contracting the footboard inwardly when the scooter is not in use thus to reduce the volume and facilitate carriage and shipping.

2) Description of the Related Art

Referring to FIGS. 1 and 2, the conventional scooter comprises a spherical handle (41), a topside stem (4), a mounting device (46), a forward frame (40), front wheels (42), a footboard (44), a rear wheel (43) and springs (45), for the user to step on the footboard (44) and manually hold the handle (41) to constitute the sliding movement; when not in use, only the handle (41) of this kind of conventional scooter can be pressed downwardly for carriage; however, since the length of the footbaord (44) remains the same, so the occupied volume is relative great, not only inconvenient for carriage and shipping, but also not ideal for taking too much storage space; such shortcomings have always irritated and troubled the manufacturers and the consumers, therefore, the necessity of providing an folding structure of scooter to specifically enhance the effect and practical value of the product is the motive of the invention herein.

### SUMMARY OF THE INVENTION

The objective of the invention herein is to provide a folding structure of scooter comprises of a front and a rear footboards and a hollow sleeve panel, with sliding grooves in the shapes of long holes disposed respectively on the side edges of the footboards and through holes situated respectively on the four corners of the sleeve panel at responding positions to the sliding grooves of the footboards for sleeving the footboards into the sleeve panel and then use the bolts to screw the through holes on the sleeve panel and the sliding grooves on the footboards to make the footboard expandable and contractable inwardly when not in use to achieve the function of reducing the volume for facilitating carriage, shipping and storage.

Another objective of the invention herein is to provide a spherical handle in three expandable sections after being contracted and pressed downwardly to be in a flush arrangement with the folded footboard.

To enable a further understanding of the main features and innovative aspects of the invention herein, the brief description of the drawings below is followed by the detailed description of the preferred embodiments.

### BRIEF DESCRIPTION OF THE DRAWINGS

FIG. 1 is an isometric drawing of the embodiment of a conventional scooter.

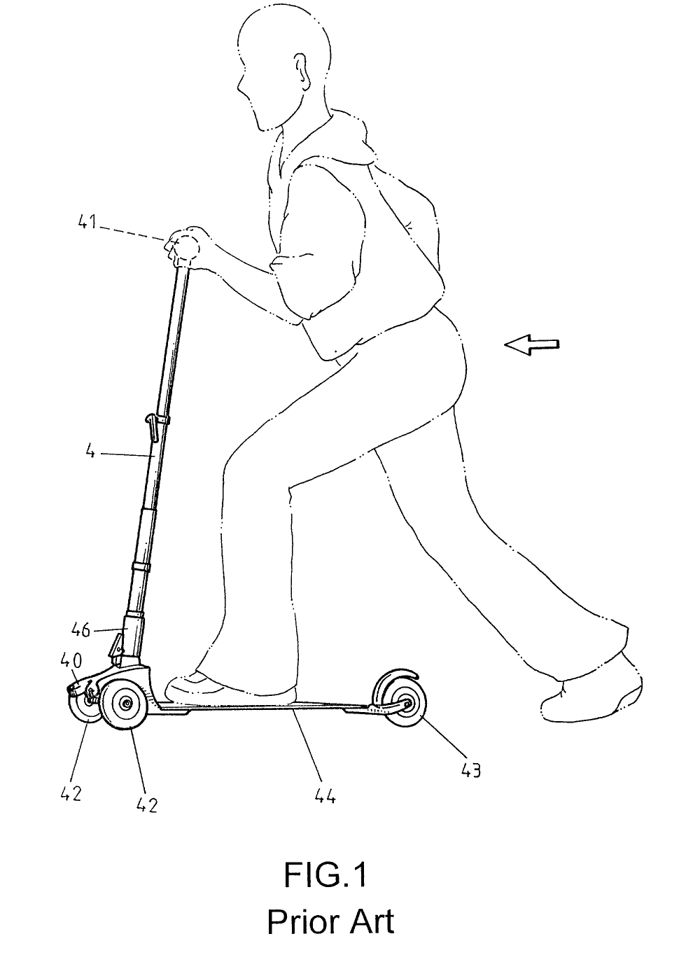

FIG. 2 is a pictorial and isometric drawing of the partial structure of a conventional scooter.

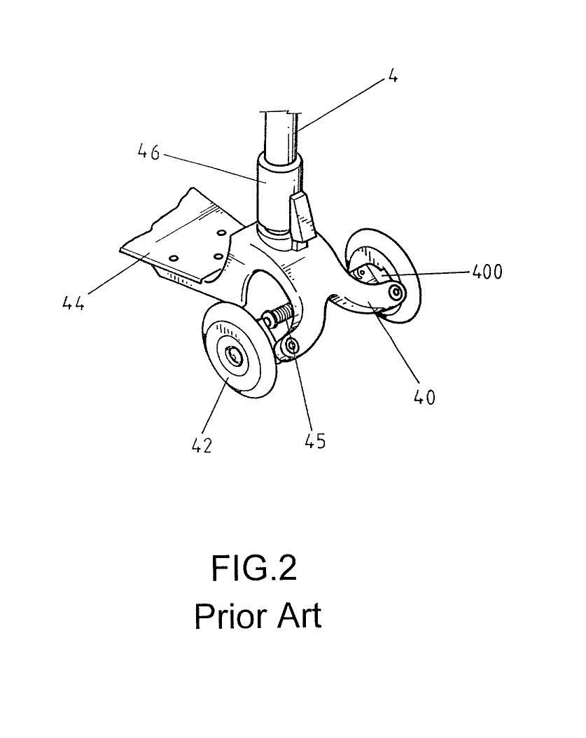

FIG. 3 is a pictorial and isometric drawing of the invention herein.

FIG. 4 is a pictorial and isometric drawing of the exploded invention herein.

FIG. 5 is an isometric drawing of the folded embodiment of the invention herein.

### DETAILED DESCRIPTION OF THE PREFERRED EMBODIMENT

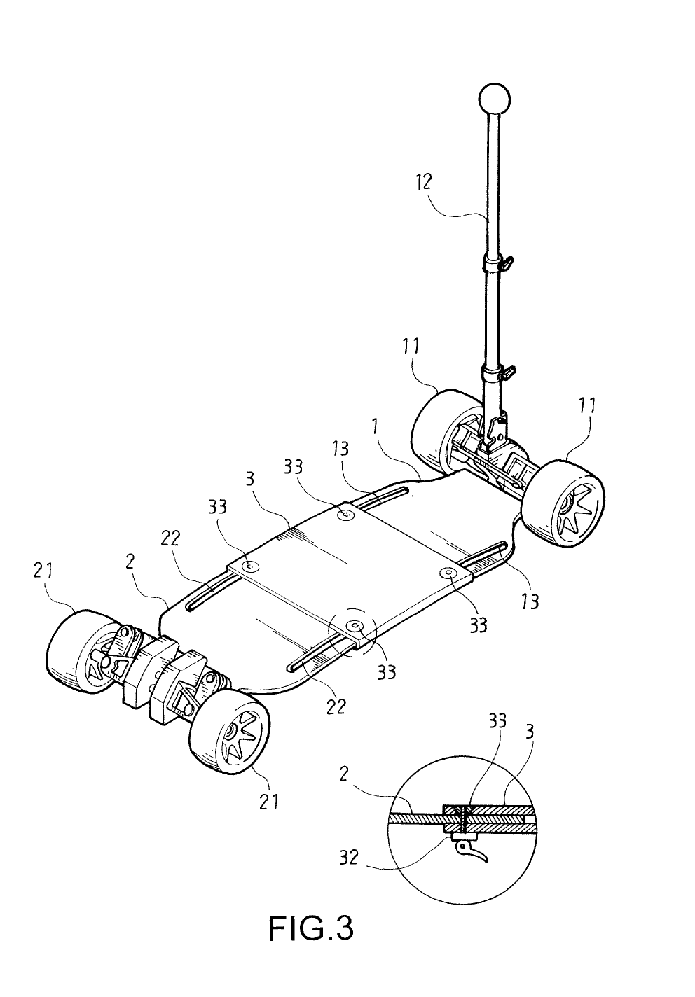

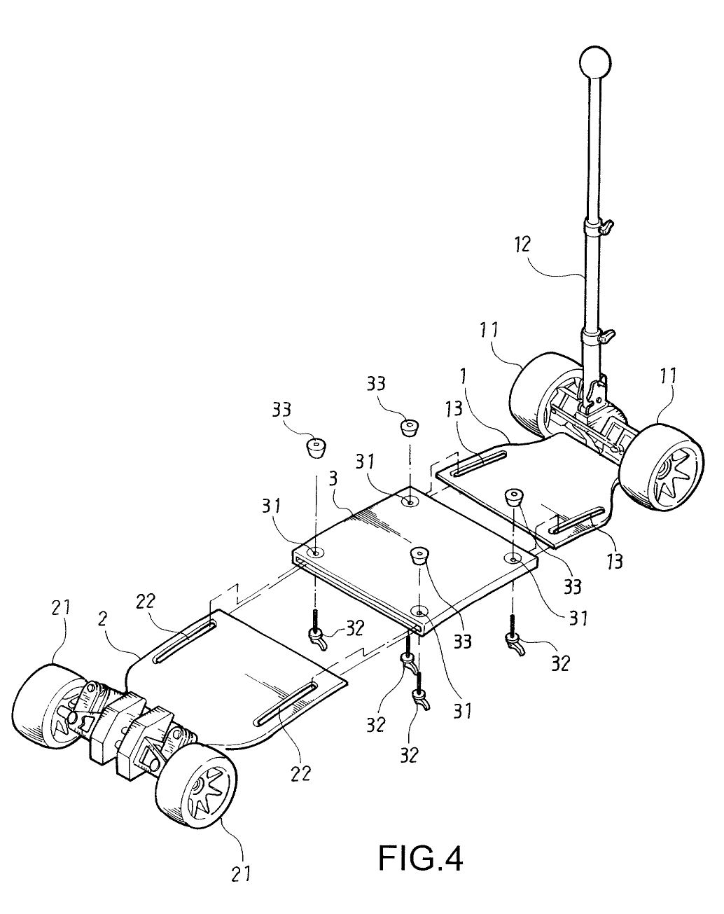

Referring to FIGS. 3 and 4, the pictorial and isometric drawings of the invention herein and of the exploded invention herein, the invention herein mainly comprises of a front and a rear footboards (1, 2) and a hollow sleeve panel (3) engaged with the front and the rear footboards (1, 2), wherein the similar front and rear wheels (11, 21) of the conventional scooter and the spherical handle (12) in three expandable sections are positioned respectively on the ends of the front and the rear footboards (1, 2), while the sliding grooves (13, 22) in the shapes of long holes are set respectively on the side edges on the front and the rear footboards (1, 2); the through holes (31) are situated respectively on the four comers of the sleeve panel (3) at responding positions to the sliding grooves (13, 22) of the footboards (1, 2) defining the top edges of the through holes (31) in flare openings for respectively sleeving the front and the rear footboards (1, 2) into the sleeve panel (3) and inserting the bolts (32) from the bottom ends of the through holes (31) on the sleeve panel (3) to the sliding grooves (13, 22) of the front and the rear footboards (1, 2) for being locked to the cone-shaped screwed caps (33) and to engage the front and the rear footboards (1, 2) with the sleeve panel (3), furthermore, the design of the flare openings of the top edges of the through holes (31) will flush the screwed caps (33) with the surface of the sleeve panel (3).

By utilizing the foregoing assembly of the structure, as the scooter is in use, the bolts (32) will be first released to allow the front and the rear footboards (1, 2) to be pulled outwards from the sliding grooves, then lock the bolts (32) tightly to form a regular footboard of a scooter for stepping on to slide; while not in use, the bolts (32) will first be released, then the front and the rear footboards will be pushed into the sleeve panel (3) and the bolts (32) will be locked tightly to shrink the length of the whole footboard to facilitate carriage, shipping and storage.

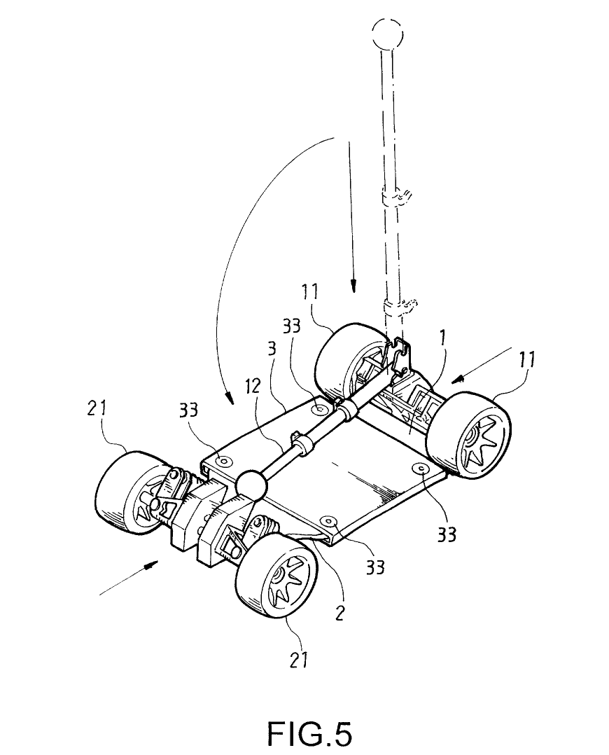

Referring to FIG. 5, the isometric drawing of the folded embodiment of the invention herein, for folding the invention herein, first the bolts (32) will be released to make the front and the rear footboards (1, 2) slide into the footboard (3) through the sliding grooves (13, 22), then the bolts (32) will be screwed tightly, the handle (12) will be contracted and pressed into flat arrangement, as such, the volume of the whole scooter will be substantially reduced not only more convenient for carriage and shipping, but also saving the storage space.

In summation of the foregoing section, the combination of the front and the rear footboards and the engaged hollow sleeve panel enabling the footboards of the scooter to be expandable and contractable for facilitating carriage and storage is of practical design and indeed an invention of innovative aspect, and is hereby submitted to the patent bureau for review and the granting of the commensurate patent rights as soon as possible.

1. A folding structure of scooter mainly comprises of a front and a rear footboards and a hollow sleeve panel engaged with the front and the rear footboards, wherein the sliding grooves in the shapes of long holes are situated respectively on the side edges of the front and the rear footboards; the through holes disposed respectively on the four corners of the sleeve panel at responding positions to the sliding grooves of the front and the rear footboards for sleeving the front and the rear footboards into the sleeve panel and then insert the bolts to screw the through holes on the sleeve panel and the sliding grooves on the front and the rear footboards to make the front and the rear footboards expandable through the sliding grooves and contractable inside the sleeve panel to achieve the objective of reducing the volume of the scooter for facilitating carriage, shipping and storage.

2. As mentioned in claim 1 of the folding structure of the scooter, wherein the top edges of the through holes of the sleeve panel are in the shapes of flare opening for interlocking the cone-shaped screwed caps to enable the bolts after being inserted to the through holes and the sliding grooves to be locked tightly to the screwed caps and flush the screwed caps with the surface of the sleeve panel for stepping on.
